(19) United States
(12) Patent Application Publication
(10) Pub. No.: US 2001/0043721 A1
(43) Pub. Date: Nov. 22, 2001

(54) Method and apparatus for performing motion analysis on an image sequence

(75) Inventors: Dina Kravets, Princeton Junction, NJ (US); Suz-Hsi Wan, Princeton, NJ (US)

Correspondence Address: THOMASON, MOSER AND PATTERSON LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/769,599

(22) Filed: Jan. 25, 2001

Related U.S. Application Data
(60) Provisional application No. 60/190,819, filed on Mar. 21, 2000.

(51) Int. Cl. G06K 9/00

(52) U.S. Cl. 382/107

(57) ABSTRACT

A method and concomitant apparatus for performing motion analysis on a sequence of images is disclosed. Initially, the sequence of images is received from a video source. The sequence of images captures a plurality of objects each moving along a trajectory in an area imaged by the video source. Motion information is extracted from the sequence of images for each of the plurality of objects. Spatial patterns are then determined from the extracted motion information.

This application claims the benefit of U.S. Provisional Application No. 60/190,819, filed Mar. 21, 2000, which is herein incorporated by reference.

This invention was made with U.S. government support under NIDL contract number NMA20297D1033 and DARPA contract number MDA97297C0033. The U.S. government has certain rights in this invention.

The invention relates generally to a method and apparatus for video processing and, more particularly, to a method and apparatus for performing motion analysis on an image sequence.

### BACKGROUND OF THE DISCLOSURE

Current research efforts have used prototype systems to perform data mining or data analysis of spatial and/or temporal information within an image sequence. The prototype systems may perform data mining in accordance to a theoretical framework from Chorochronos, a European-based research network for spatio-temporal database systems. Chrorochronos has addressed concerns related to generating datasets, data models, objects and representations of objects.

One existing system implements data mining to determine patterns from spatial data. See Han et al., “GeoMiner: A System Prototype for Spatial Data Mining,” Proceedings of the ACM SIGMOD International Conference on Management of Data, 1997. Other prototype systems implement data mining to determine patterns from temporal data. See Spiliopoulou, “Discovering Patterns in Sequences,” Dagstuhl Seminar 98471, Dagstuhl, Germany, 1998; and Han et al., “Efficient Mining of Partial Periodic Patterns in Time Series Database,” Proceedings of International Conference on Data Engineering, 1999.

In Spiliopoulou, the data mining is performed on a time dimension as an ordered lattice, i.e., the only operands on the time variable are “before” and “after.” Such data mining over the ordered lattice is not performed over time as a continuous variable but on time as a sequential variable. More recent work by Spiliopoulou and Han et al. have performed data mining over time as a discrete-valued variable. However, both Spiliopoulou and Han et al. have converted the time variable into a sequence of characters such that data mining for text is used to mine or analyze time-based sequences of events.

Another existing system performs data mining on data having both spatial and temporal components. See Stolorz et al., “Fast Spatio-Temporal Data Mining from Large Geophysical Datasets,” Proceedings of the First International Conference on Knowledge Discovery and Data Mining, IEEE Press, 1995. Stolorz et al. determines limited weather patterns by using parallel computers to automatically detect cyclones and blocking conditions from a large geophysical dataset with temporal components.

The existing systems are limited in applying data mining to numerical or one-dimensional data. However, with the increased use of video data, there is a need for a method and system to extend mining to video data, i.e., perform motion mining on a video sequence.

### SUMMARY OF THE INVENTION

The present invention is a method and apparatus for performing motion analysis on a sequence of images. Initially, the sequence of images is received from a video source. The sequence of images captures a plurality of objects each moving along a trajectory in an area imaged by the video source. Motion information is extracted from the sequence of images for each of the plurality of objects. Spatial patterns are then determined from the extracted motion information and used for performing functions such as intelligence assessment, traffic control and airport security.

### DESCRIPTION OF THE DRAWINGS

The teachings of the present invention can be readily understood by considering the following detailed description in conjunction with the accompanying drawings, in which:

FIG. 1 depicts a block diagram of a video processing system for performing motion analysis on a video sequence and displaying the analyzed motion in response to a database query;

FIG. 2A depicts raw data received by a motion extraction system of the video processing system;

FIG. 2B depicts exemplary motion information derived from the raw data by the motion extraction system;

FIG. 3 depicts exemplary motion patterns determined from a motion mining system of the present invention;

FIG. 4 depicts a block diagram of one embodiment of the motion mining system;

FIG. 5 depicts an example graphical user interface (GUI) for displaying motion information at the user computer of the video processing system;

FIG. 6 depicts an exemplary set of possible patterns and constraints implemented in the GUI of FIG. 5;

FIG. 7 depicts an exemplary timeline window accessible as a menu option from the GUI of FIG. 5;

FIG. 8 depicts an exemplary details window accessible as a menu option from the GUI of FIG. 5;

FIG. 9 depicts a flow diagram of a method for implementing the video processing system of FIG. 1; and

FIG. 10 depicts a flow diagram of a method for implementing the motion mining system of the present invention.

To facilitate understanding, identical reference numerals have been used, where possible, to designate identical elements that are common to the figures.

### DETAILED DESCRIPTION

The present invention is a method and apparatus for performing motion analysis on a sequence of images. Initially, a sequence of images is received from a video source. The sequence of images captures a plurality of objects each moving along a trajectory in an area imaged by the video source. Motion information is extracted from the sequence of images for each of the plurality of objects. Spatial patterns are then determined from the extracted motion information. The invention also determines temporal and spatio-temporal patterns from the extracted motion information. These spatial, temporal and spatio-temporal motion patterns support various applications and functions. For example, these motion patterns are used to perform such functions as intelligence assessment, mission planning, counter terrorism, counter drug traffic, traffic control, airport security, and urban policing.

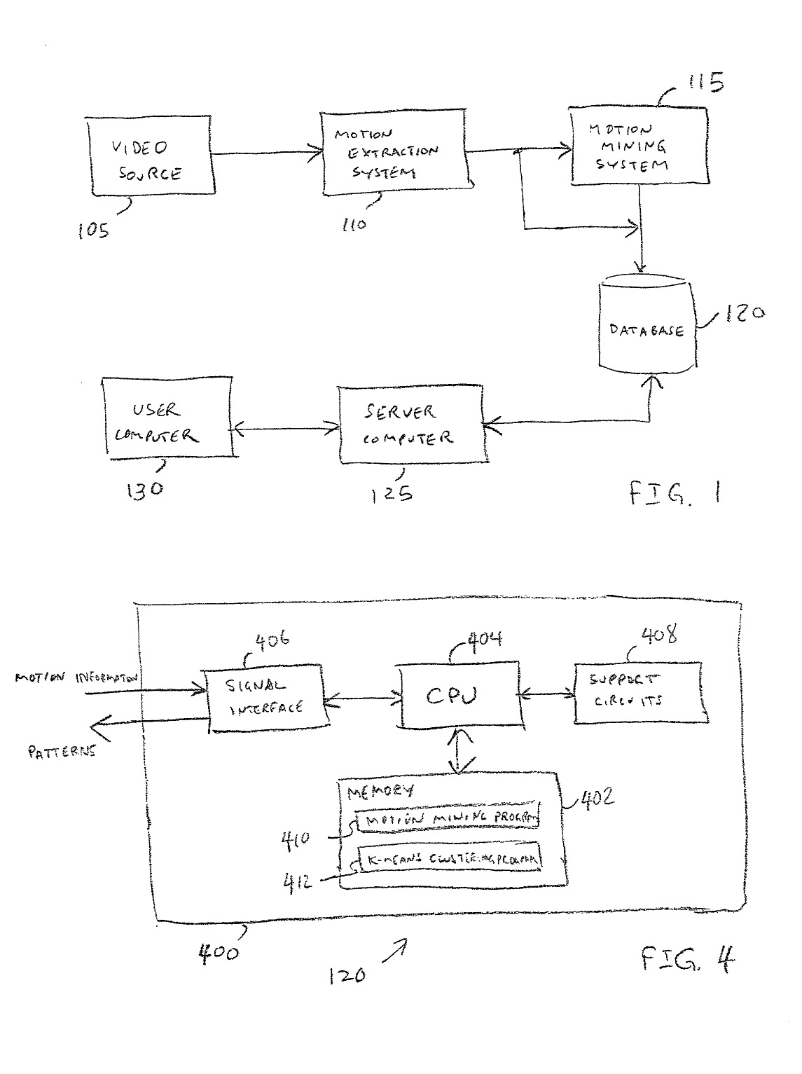

FIG. 1 depicts a block diagram of the video processing system 100 of the present invention. The video processing system 100 performs motion analysis on a video sequence and displays the analyzed motion information in response to a database query. Specifically, the video processing system 100 comprises a video source 105, a motion extraction system 110, a motion mining system 115, a database 120, a server computer 125 and a user interface unit 130.

The video source 105 images a particular area and captures video or an image sequence of the imaged area. Once the video is captured, the video source 105 transmits the captured video to the motion extraction system 110. In one embodiment, the captured video contains a plurality of objects moving in the imaged area. Objects may include people and moving vehicles, e.g., airplanes and automobiles. Examples of the video source 105 include a stationary or moving video camera positioned on a unmanned air vehicle (UAV) or a ground-based video camera, i.e., a camera positioned on a traffic light, and a satellite-based video camera. The video source 105 may also comprise recorded video if the location of objects can be extracted from the recorded video by the motion extraction system 110.

In the present invention, the motion in the video is represented as raw data 201 depicted in FIG. 2A. The raw data 201 comprises coordinates (id, x, y, z, t) in 5-dimensional space, where id represents an object identifier, and x, y and z represent a location of the object at a time t. A maximal sequence of points {(id, x₀, y₀, z₀, t₀), (id, x₁, y₁, z₁, t₁), . . . , (id, Xₖ, yₖ, zₖ, tₖ)} defines the motion of a moving object, where t₀<t₁<. . . <tₖ and the object moves from location (xᵢ, yᵢ, _{z}i) at time tᵢ to location (xᵢ₊₁, yᵢ₊₁, zᵢ₊₁) at tᵢ₊₁, for all 0<i<k. A contiguous portion of the motion is depicted in FIG. 2A as a “trajectory” 202 of the moving object. The location (xᵢ, yᵢ, zᵢ) of the object, i.e., the raw data 201, is produced by a global positioning system (GPS), while the time ti represents a timestamp at the video source 105.

The time interval between two successive points is defined by the motion extraction system 110. For a nominal frame rate of 30 frames per second, the time interval may be on the order of one second. In other words, the motion extraction system 110 may periodically process frames, e.g., every thirtieth frame, to reduce the amount of video for processing but maintain an appreciable degree of accuracy. The exact time interval between successive points is dependent on the type of object among other factors, e.g., weather conditions. For example, a video tracking the presence of aircraft would generally require a shorter time interval than a video tracking of the presence of automobiles.

The motion extraction system 110 receives the video or image sequence from the video source 105 and extracts motion information from the received information. An exemplary motion extraction system 110 is provided by the Sarnoff Corporation in U.S. Pat. No. 5,259,040, issued to Hanna on Nov. 2, 1993, which is herein incorporated by reference. FIG. 2B depicts exemplary motion information 206 extracted from the trajectory 202 of each moving object by the motion extraction system 100. Examples of such motion information 206 include a trajectory time span, a trajectory region, a trajectory start point, a trajectory end point, a direction of the trajectory, a speed range of the trajectory, an acceleration range of the trajectory, a shape of the trajectory and a path of the trajectory. Additionally, if the received video contains ESD (electronic sensor data), the motion information 206 also includes the geolocation, i.e., geographical position, of the moving objects. The motion information 206 for each trajectory 202 is then transmitted to the motion mining system 115 and the database 120.

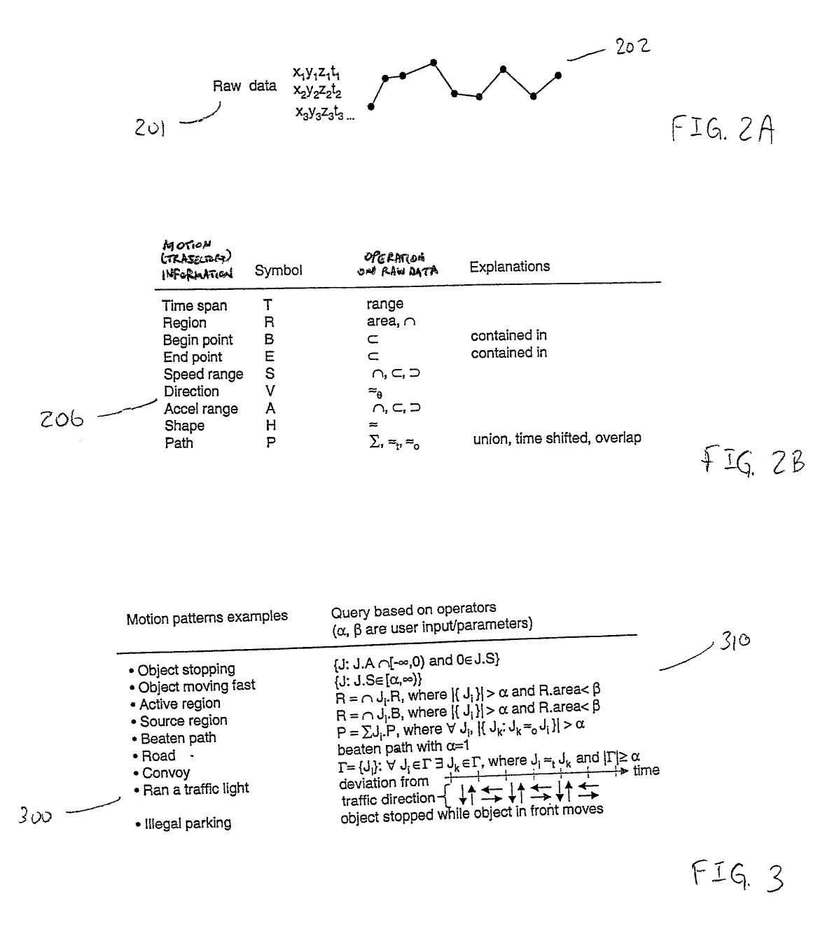

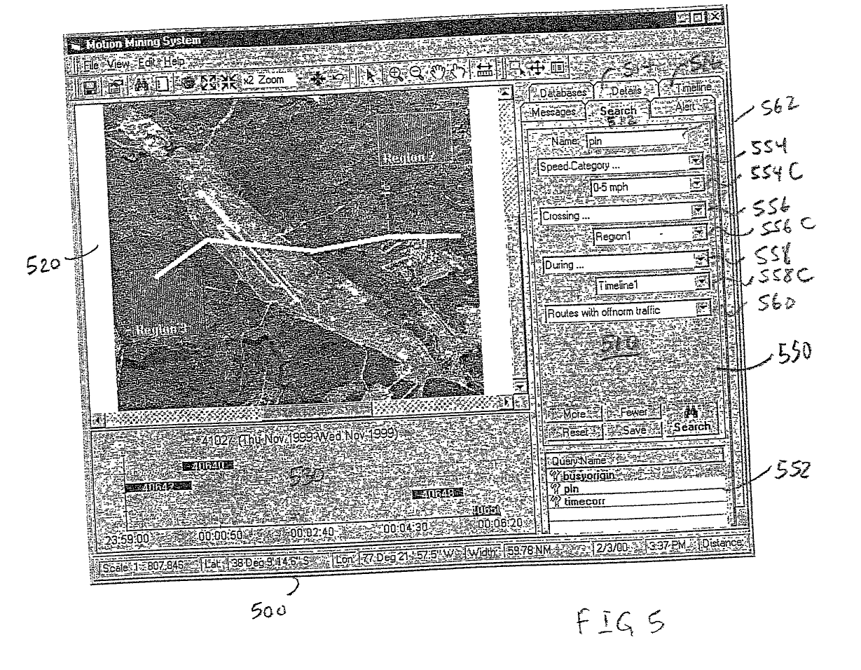

The motion mining system 115 receives the extracted motion information from the motion extraction system 110 and determines spatial, temporal and spatio-temporal patterns from the motion information 206 received from the motion extraction system 110. These motion patterns are then transmitted to and stored in the database 120. FIG. 3 depicts exemplary motion patterns 300 as determined by the motion extraction system 110. The motion patterns 300 are provided in response to a database query 310 at the user computer 130. Examples of these motion patterns 300 include but are not limited to: an object stopping, a fast moving object, an active region, a source region, a “beaten” path, a road or route, a convoy, a violation of a traffic light and illegal parking.

In one embodiment, the motion mining system 115 may determine spatial patterns without regard to a particular time. The motion mining system 115 may perform “routes clustering,” i.e., determine the existence of “routes” by clustering or grouping of trajectories 202 of at least two objects traveling along the same path. Each route is determined in an iterative manner. For example, if any portion of a trajectory 202 is close, e.g., within a threshold distance, to a previously considered trajectory or a previously considered route, then the portion is combined to form a new route.

After clustering or grouping the trajectories into routes, the motion mining system 115 may also cluster each route in the time dimension. The clustering of routes in the time dimension represents a “busy time” along the route. For example, the motion mining system 115 determines whether the number of trajectories along the route exceeds a threshold number at different times. To determine such “busy times” along each route, the motion mining system 115 uses a clustering process, e.g., a “K-means” clustering process. Examples of the K-means process are shown in Bradley et al., “Refining Initial Points for K-Means Clustering,” Proceedings of the Fifteenth International Conference on Machine Learning, 1978, pages 91-99; and Hartigan et al., “A K-Means Clustering Algorithm,” Applied Statistics, Vol. 28, No. 1, 1979, pages 100-08.

The determined busy time represents a particular time or time interval when the number of trajectories in the route is greater than a threshold number. The exact value of the threshold number is dependent upon different factors, e.g., the type of object, the time interval under consideration and the region or location of the imaged area. For example, a busy time along a particular route may represent a morning rush hour.

The motion mining system 115 may also cluster or group trajectories to determine popular origins and popular destinations. In one embodiment, the motion mining system 115 uses the start and end points of various trajectories to determine popular source and destination points. If the number of trajectories 202 starting from the region or location is greater than a threshold number, the region or location is identified as a popular origin or source point. Similarly, if the number of trajectories 202 ending at a region or location is greater than the threshold number, the region or location is identified as a popular destination or sink point. The exact value of the threshold number is dependent upon different factors, e.g., the type of object, the time interval under consideration and the region or location of the imaged area. As with the clustering of routes along the time dimension, the motion mining system 115 may use a clustering process, e.g., a K-means clustering process, to identify regions containing many origins of trajectories and regions containing man destinations of trajectories.

Once the spatial patterns, e.g., routes, source points and sink points, are determined, the motion mining system 115 determines whether temporal or periodic patterns exist along the routes. Namely, the motion mining system 115 determines, for each “time scale” within a predefined set of time scales, whether there is any temporal pattern or periodicity in the time dimension along each route.

A time scale represents a time interval where two events are considered to have simultaneously occurred if the events occurred within the same time interval. For example, if the time scale is one hour, a first event at 10:12 AM is considered to have simultaneously occurred with a second event at 10:43 AM. By using a predefined time scale, the motion mining system 115 identifies periodic behavior over time intervals. For example, if the motion mining system 115 is to detect events occurring every Tuesday morning using an one hour time scale, then the following event sequence may be identified as a pattern: 12/28/99 at 10:12 AM, 1/4/00 at 10:43 AM, 1/11/00 at 10:21 AM, and 1/18/00 at 10:56 AM. As such, the motion mining system 115 detects events periodically occurring within a time range and is not limited to strictly periodic events, i.e., events occurring at exactly the same time. Exemplary time scale values are one minute, five minutes, one hour, one day and one week. However, a person of ordinary skill may also use other time scale values to determine periodicity.

The motion mining system 115 may also determine a “time correlation” between different routes for different time scales. Namely, the motion mining system 115 determines, for each pair of routes separated by less than a threshold distance apart, whether a trajectory 202 in one route is followed at the same time interval by a trajectory 202 in another route. For example, if the time scale is one hour, the following events is considered a four hour time correlation between a first route and a second route: events occurring on 12/28/99 at 10:12 AM, 1/4/00 at 10:43 AM, 1/11/00 at 10:21 AM and 1/18/00 at 10:56 AM over the first route, and events occurring on 12/28/99 at 2:33 PM, 1/4/00 at 2:18 PM, 1/11/00 at 2:26 PM and 1/18/00 at 2:34 PM over the second route.

The motion mining system 115 is not limited to the above-identified patterns. For example, the motion mining system 115 may apply a pattern operator 210 to determine a time periodicity of a particular object within a route. The motion mining system 115 may also identify fast-moving objects and slow-moving objects having trajectory speeds within particular ranges. Additionally, the motion mining system 115 may apply a deviation operator 212 to determine any deviations or violations from a previously determined pattern.

The above-mentioned motion patterns are used in a variety of practical applications. Such applications that use these motion patterns include: discovering periodic patterns of flights, determining whether different flights are time-correlated, finding regions of heavy influx of vehicles over the last week, finding regions of heavy outflow of vehicles, predicting the location of an object in the next hour, and predicting any suspicious patterns between two objects. Additionally, applications that use deviations of motion patterns include: finding objects flying in a region having no commercial routes, detecting a fast moving object in a no-fly zone, determining whether a vehicle has reversed its path near a road block, determining whether a vehicle is moving faster than average, detecting speeding objects, and detecting objects with unusual acceleration. These applications are exemplary and are not considered to be limiting in any manner.

The database 120 contains at least the above- identified motion patterns from the motion mining system 115 and motion information from the motion extraction system 110. The motion patterns and motion information represent motion of a plurality of objects in a imaged area and over a particular time interval. The server computer 125 accesses and uses the data in the database to perform calculations in response to a query from the user computer 130. The query results are displayed as a graphical user interface (GUI) at the user computer 130. An exemplary GUI is further described with respect to FIGS. 5-8.

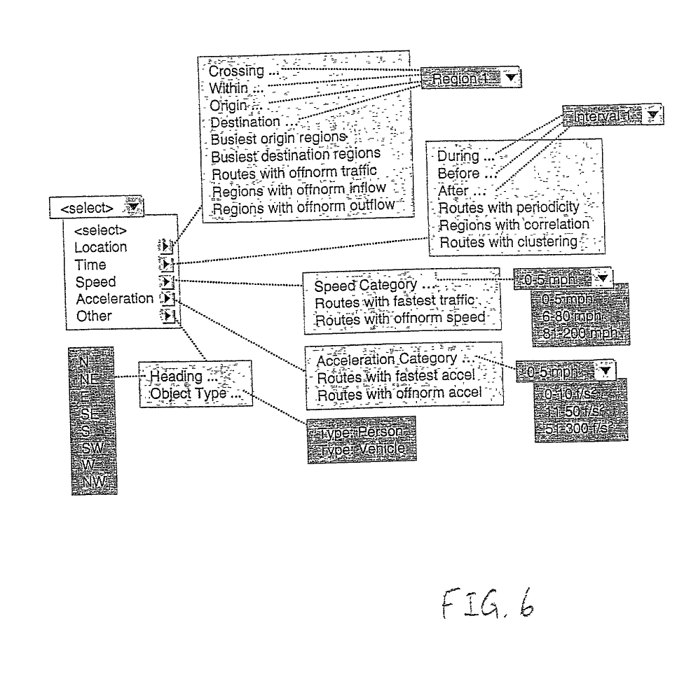

FIG. 4 depicts one embodiment of the motion mining system 115 of the present invention. The motion mining system 115 is embodied as a computer 400 comprising a memory 402, a central processing unit (CPU) 404, a signal interface 406 and support circuits 408. The memory 402 stores software programs, e.g., a motion mining program 410 and a K-means clustering program 412. The motion mining program 410, when executed by the CPU 404, is used to implement the motion mining system 115. The K-means clustering program 412 is used to determine source points, target or destination points, and the busy times along routes.

The signal interface 406 receives motion information from the motion extraction system 110. Once the motion information is received at the signal interface 406, the CPU 404 executes instructions or commands in the motion mining program 410 to determine spatial patterns, temporal patterns and spatio-temporal patterns from the received motion information. The CPU 404 may use well-known support circuits 408 to implement the motion mining program 410. Examples of support circuits 408 may include a clock, a power supply, a cache memory, and the like. The signal interface 406 then transmits the patterns to the database 120. Examples of the signal interface 406 include a cable modem, a network card, and the like.

FIG. 5 depicts an exemplary graphical user interface (GUI) 500 for displaying motion information and motion patterns. A user may use the GUI 500 to specify a database query on the motion patterns and motion information stored in the database 120. The results of the query are then displayed on the GUI 500. Specifically, the GUI 500 comprises menu window 510, a map window 520 and a timeline window 530.

The menu window 510 includes a search tab 512, a details tab 514 and a timeline tab 516. The menu window 510 may also include additional tabs, e.g., a messages tab, an alert tab and a database tab. If the search tab 512 is selected, the menu window 510 displays a search window 550 containing a list 552 of predefined queries and fields 554, 556, 558 and 560 to define a selected query. For example, the list 552 may include queries to determine busy source points, routes and deviations thereof, and a time correlation between different routes.

The fields 554-560 are used to define the query with selected categories motion patterns and motion information 206 and with selected values of constraints. The type and number of available fields or option windows 554-560 is dependent on the type of query to perform. The constraints selected in the fields 554C, 556C and 558C are limitations to a particular motion pattern or a particular type of motion information 206. An exemplary set 600 of motion patterns, motion information 206 and constraints are depicted in FIG. 6. Such constraints, shown as shaded in the set 600, may define a speed range, an acceleration range, a direction of an object, a type of object, a time interval relative to an event, and a region relative to a trajectory 202.

The search window 550 depicted in FIG. 5 indicates the selection of a query “pln” as indicated in field 562. This query is used to determine the existence of a particular type of route. The query is specified by a speed category in field 554, a crossing condition in field 556, a time frame in field 558 and an existence of off-norm traffic in field 560. Constraints are provided in field 554C for a speed range, in field 556C for a region being crossed, and field 558C for objects travelling in a specified time frame.

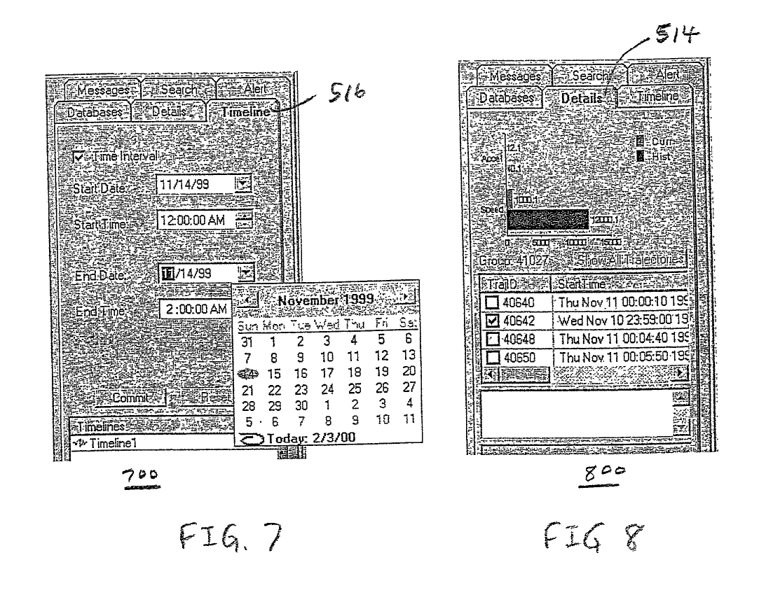

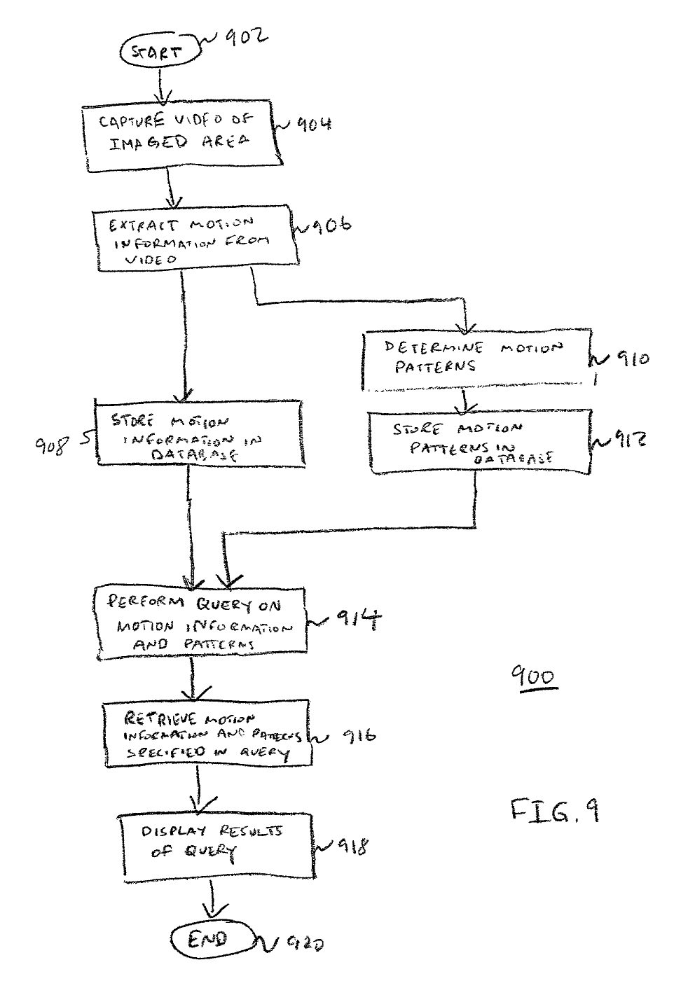

The selection of the timeline tab 516 results in the display of a timeline window 700 depicted in FIG. 7. The timeline window 700 contains fields for defining the start and end of a time frame or time interval of interest. Once the query is performed and the query result is displayed on the map window 520, the user may select the details tab 514 to display a details window 800 depicted in FIG. 8. The details window 800 indicates information of each trajectory that satisfies the query specified in the query window 550. For example, the details window 800 may indicate the object identifier and the start time for the trajectory of the object.

The map window 520 displays the routes that satisfy the query specified in the search window 550. Namely, the map window provides a spatial representation of an area captured in the video. The creation of the map window 520 includes the display of a background image of the imaged area and then overlaying the background image with routes that satisfy the query.

The timeline window 530 displays the object identifier and time span of each trajectory in the routes shown in the map window 520. Thus, the timeline window 530 provides a temporal representation of the trajectories for each route. The range of time is specified in the timeline window 700. Specific information for each trajectory is displayed in the details window 800.

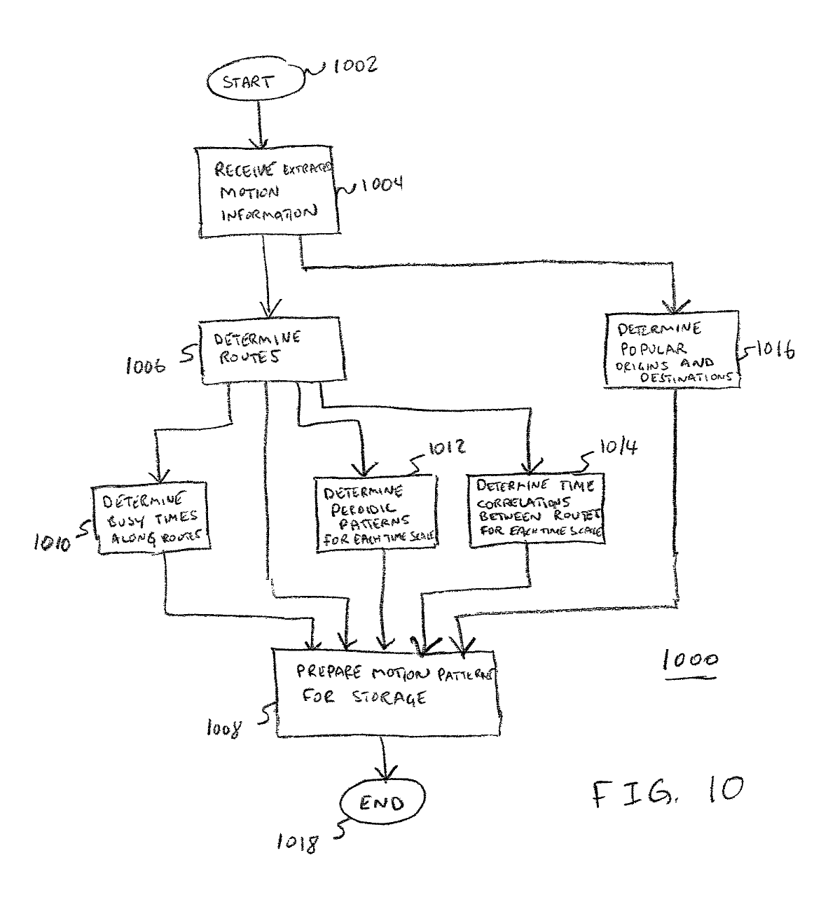

FIG. 9 depicts a flow diagram of a method 900 for implementing the video processing system 100. The method 900 starts at step 902 and proceeds to step 904, where the video source 105 captures video of the imaged area of interest. At step 906, the method 900 uses the motion extraction system 110 to extract motion information 206 from the video. Motion information 206 includes information relating to a trajectory 202 of a moving object captured in the video. Examples of motion information 206 include a path of the trajectory 202, a speed range of the trajectory 202, and a start point of the trajectory 202.

At step 908, the method 900 stores the extracted motion information 206 in the database 120. The method 900 uses the extracted motion information at step 910, where the inventive motion mining system 115 determines motion patterns from the extracted motion information 206. Step 910 is further described with respect to FIG. 10. The method motion patterns are stored in the database 120 at step 912.

The method 900 proceeds to step 914, where a server computer 125 performs a query on the stored motion information 206 and motion patterns. The query is performed in response to a command from a user at the user computer 130. The query may contain constraints used to specify particular categories or ranges of motion information 206 and motion patterns. At step 916, the motion information 206 and motion patterns specified in the query are retrieved from the 120. The method 900 proceeds to step 918, where the results of the query are displayed through a graphical user interface (GUI) at the user computer 130. Steps 914, 916 and 918 are used to perform each query specified by the user. The method 900 proceeds to end at step 920.

FIG. 10 depicts a flow diagram of a method 1000 for implementing the motion mining system 115 of the present invention. The motion mining system 115 performs the method 1000 in accordance to commands in the motion mining program 410. Specifically, the method 1000 starts at step 1002 and proceeds to step 1004, where motion information 206 is received from the motion extraction system 110.

The motion information is used to determine routes at step 1006. Routes represent the grouping or clustering of two or more trajectories having a common path. The information on the routes is prepared for storage at step 1008. For example, information from step 406 may be temporarily stored in the memory 402 or support circuits 408 of the motion mining system 115 or may be directly stored in the database 120.

At step 1010, the method determines busy times along each of the routes. Specifically, for each route, step 410 performs clustering of the trajectories along the time dimension. The busy times or intervals represent the times when the number of trajectories is greater than a predetermined threshold number. The information from step 1010 is prepared for storage at step 1008.

The method 1000 also uses the information on routes in step 1012, where periodic patterns are determined for each route. The determination of periodic patterns uses the concept of a time scale that represents a time interval where two events are considered to have occurred simultaneously if the events occurred within the same time interval. As such, step 1012 is not limited to strictly periodic patterns but captures additional periodic patterns within a predefined time interval or time scale. The information from step 1012 is also prepared for storage at step 1008.

At step 1014, the method 1000 also uses information from step 1006 to determine time correlations between two different routes for different time scales. For each pair of trajectories 302 separated within a threshold distance, step 1014 determines whether a trajectory 302 in a first route is followed at the same time interval by another trajectory 302 in a second route. The information on time correlation is prepared for storage at step 1008.

The method 1000 uses the received motion information 206 to determine popular origins and destinations at step 1016. The popular origins and destinations are determined by grouping or clustering common start points and common end points of trajectories 302. For example, step 1016 identifies a popular origin if the number of trajectories having a common start point is greater than a threshold number. Similarly, step 1016 identifies a popular destination if the number of trajectories having a common end point is greater than a threshold number. The information on popular origins and destinations is prepared for storage at step 1008. The method 1000 proceeds to end at step 1018 once all the motion patterns are determined from steps 1006, 1010, 1012, 1014 and 1016.

Although various embodiments which incorporate the teachings of the present invention have been shown and described in detail herein, those skilled in the art can readily devise many other varied embodiments that still incorporate these teachings.

What is claimed is:

1. A method for performing motion analysis on a sequence of images, where said sequence of images captures a plurality of objects each moving along a trajectory in an imaged area, said method comprising:
extracting motion information for each of said plurality of objects contained in said sequence of images; and
determining spatial patterns from said extracted motion information.

2. The method of claim 1 wherein said determining of spatial patterns comprises:
determining a route comprising a trajectory of a first object having the same trajectory of at least one other object.

3. The method of claim 2 wherein said determining of said route comprises:
determining whether said trajectory of a second object is within a threshold distance said trajectory of said first object; and
including, if said trajectory of said second object is within the threshold distance, said trajectory of said second object in said route.

4. The method of claim 1 wherein said determining of spatial patterns comprises:
determining a source point and a destination point from said trajectory of said plurality of objects.

5. The method of claim 4 wherein said determining said source point comprises:
determining whether a number of trajectories originating from a location is greater than a threshold number; and
identifying, if the number of trajectories originating from the location is greater than the threshold number, the location as said source point.

6. The method of claim 4 wherein said determining said destination point comprises:
determining whether a number of trajectories ending at a location is greater than a threshold number; and
identifying, if the number of trajectories ending at the location is greater than the threshold number, the location as said destination point.

7. The method of claim 4 wherein said source point and said destination point are determined using a clustering process.

8. The method of claim 1 further comprising:
determining spatio-temporal patterns from said determined spatial patterns along a time dimension.

9. The method of claim 8 wherein said determining of spatio-temporal patterns comprises:
determining a busy time for said route, where the busy time represents a time when a number of trajectories for said plurality of objects along said route is greater than a threshold number.

10. The method of claim 8 wherein said determining of spatio-temporal patterns comprises:
determining a periodicity of at least one trajectory in said route.

11. The method of claim 10 wherein said determining the periodicity comprises:
selecting a time scale; and
determining whether a first occurrence of an event along said route and time scale is periodic with subsequent occurrences of said event along the same route and time scale.

12. The method of claim 11 wherein said event comprises said trajectory of said first object.

13. The method of claim 11 wherein said event comprises a number of said trajectories greater than a threshold value.

14. The method of claim 1 further comprising:
determining a first route comprising a trajectory common to a first set of at least two objects;
determining a second route comprising a trajectory common to a second set of at least two objects; and
determining whether said trajectory in said first route is time correlated with said trajectory in said second route.

15. A method for displaying motion information of objects contained in a sequence of images, the method comprising:
performing a query on a plurality of spatial patterns stored in a database, where each of said plurality of spatial patterns comprises a route determined from a trajectory common to at least two objects moving in an imaged area captured in said sequence of images;
determining a trajectory satisfying at least one constraint specified in said query; and
displaying said determined trajectory on a user interface.

16. A system for performing motion analysis on a sequence of images, the apparatus comprising:
a motion extraction system for receiving said sequence of images capturing a plurality of objects each moving along a trajectory, and extracting motion information for each of said plurality of objects over said sequence of images; and
a motion mining system for determining spatial patterns from said extracted motion information, where said spatial patterns comprise a route determined from said trajectory common to at least two objects.

17. The system of claim 16 further comprising a video source for capturing said plurality of objects in an imaged area and transmitting video containing said captured plurality of objects to said motion extraction system.

18. The system of claim 16 further comprising:
a database for storing said spatial patterns determined from said motion mining system; and
a server computer for retrieving said trajectory satisfying at least one constraint specified in a query.

19. The system of claim 16 wherein said spatial patterns comprise a route having a trajectory of a first object that is the same as the trajectory of at least one other object.

20. The system of claim 16 wherein said spatial patterns comprise a source point and a destination point for said trajectories of said plurality of objects.

21. The system of claim 16 wherein said motion mining system determines spatio-temporal patterns from said spatial patterns along a time dimension.

22. An apparatus for performing picture analysis, the apparatus comprising:
a memory for storing a motion mining program;
an interface for receiving motion information containing trajectory information for a plurality of objects captured in an image sequence;
a processor, upon executing said motion mining program retrieved from said memory, determines spatial patterns from the received motion information.

23. The apparatus of claim 22 wherein said spatial patterns comprise a route having a trajectory of a first object that is the same as the trajectory of at least one other object.

24. The apparatus of claim 22 wherein said spatial patterns comprise a source point and a destination point for said trajectories of said plurality of objects.

25. The apparatus of claim 22 wherein said processor determines spatio-temporal patterns from said spatial patterns along a time dimension.
